(19) United States
(12) Patent Application Publication
(10) Pub. No.: US 2004/0013966 A1
(43) Pub. Date: Jan. 22, 2004

(54) Method and apparatus for recording image

(76) Inventor: Yoshiharu Sasaki, Shizuoka (JP)

Correspondence Address: YOUNG & THOMPSON, 745 SOUTH 23RD STREET 2ND FLOOR, ARLINGTON, VA, 22202

(21) Appl. No.: 10/176,580

(22) Filed: Jun. 24, 2002

(30) Foreign Application Priority Data
Jun. 22, 2001 (JP) 2001-189913

(51) Int. Cl. G03C 8/50

(52) U.S. Cl. 430/254

(57) ABSTRACT

An image is formed on a non-flexible sheet member by laying and tightly adhering an image transfer sheet having a photo-thermal conversion layer and an image forming layer onto the non-flexible sheet member, scanning the image transfer sheet from the back with laser spots so that only areas of the image forming layer affected by heat developed in the photo-thermal conversion layer correspondingly to a scanned pattern are fused to the non-flexible sheet member, and peeling the image transfer sheet from the non-flexible sheet member.

### BACKGROUND OF THE INVENTION

1. Field of the Invention

The present invention relates to a method and apparatus for recording information such as images, letters, patterns and the like on recording medium such as glass, stone, metal, ceramics and the like.

2. Description of the Related Art

A display surface of a display device is sometimes formed with black stripes or a black matrix with an attempt to improve a contrast ratio. When forming black stripes on, for example, a cathode-ray tube, an ultraviolet-curing resin layer coated on a front surface of the cathode-ray tube is exposed to a pattern of ultraviolet light corresponding to the black stripes and then developed so as to solidify only exposed areas of the ultraviolet-curing resin layer. The ultraviolet light is provided by color selection means. There is left the given pattern of ultraviolet-curing resin layer on the cathode-ray tube at the front surface by removing the unexposed areas of the ultraviolet-curing resin layer from the cathode-ray tube. Thereafter, carbon powder is applied onto the front surface of the cathode-ray tube and the ultraviolet-curing resin is decomposed and removed using a reversing agent, so as thereby to form carbon black stripes on the front surface of the cathode-ray tube.

It is general to form black stripes on a transparent display base plate of a liquid crystal display device with the intention of preventing the liquid crystal display device from an escape of light between pixel electrodes in order to increase a contrast ratio. The process of forming black stripes on the liquid crystal display device does not use the color selection means and, in consequence, differs from the process of forming black stripes on the cathode-ray tube. That is, the process of forming black stripes on the liquid crystal display device could conceivably employ, for example, exposing an image transfer sheet superposed on an image receiving sheet to a laser beam. Such the process can be applied to forming pattern images on a flexible image record sheet such as a transparent flexible polyethylene telephthalate (PET) sheet using a conventional recording apparatus 1 such as shown in FIG. 27 by way example.

As shown in FIG. 27, the conventional recording apparatus 1 has a image receiving sheet feed device 3 operative to feed an image receiving sheet 7 to a scanning station 5 and an image transfer sheet feed device 9 operative to selectively feed different types of image transfer sheets 11 to the scanning station 5. The scanning station 5 is provided with a cylindrical recording drum 13 on which the image receiving sheet 7 and the image transfer sheet 11 are superposed and fixedly wound around. The image transfer sheet 11 superposed on the image receiving sheet 7 is scanned with a laser spot on the basis of data of given image such as black stripes. As a result, only areas of the image transfer sheet 11 generate heat in a pattern corresponding to the back stripes and, then, only areas of a toner layer of the image transfer sheet 11 affected by the heat are transferred to the image receiving sheet 7 due to deterioration in adhesion, fusion or sublimation. Bt repeating the process, a black matrix or a color filter comprising red, green and blue stripes separated by black stripes from one another can be formed on a flexible image record sheet.

However, the use of the recording apparatus 1 equipped with the cylindrical recording drum 13 has the necessity of employing an image record medium comprising a polyethylene telephthalate (PET) base support. Accordingly, it is impossible to use the recording apparatus 1 for forming a black matrix or a color filter on a glass base plate of a liquid crystal display device and also for forming an image on tiles, stone plates and ceramic plates, metal plates or sheets, etc. all of which are too rigid to be wound around the cylindrical recording drum 13.

### SUMMARY OF THE INVENTION

It is an object of the present invention to provide a method and an apparatus for recording a high quality of image on non-flexible record mediums that are too rigid to be wound around a cylindrical recording drum.

The above object of the present invention is accomplished by an image forming method of forming an image on a non-flexible sheet member having an image forming surface on a support that is positioned in a scanning station by transferring an image formed in an image transfer sheet having a photo-thermal conversion layer and an image forming layer to the non-flexible sheet member. The image forming method comprises the steps of: laying the image transfer sheet on the non-flexible sheet member with the image forming layer in tight adhesion to the image recording surface of the non-flexible sheet member; scanning the image transfer sheet from the back with a plurality of laser spots so that only areas of the image forming layer affected by heat developed in the photo-thermal conversion layer correspondingly to a pattern of exposure to the laser spots are fused to the image recording surface of the non-flexible sheet member; and peeling the image transfer sheet from the non-flexible sheet member so as thereby to form a positive reproduction of the image on the non-flexible sheet member.

The non-flexible sheet member preferably has a flexibility or a rigidity defined by a longitudinal modulus greater than a specified value and the product of the longitudinal modulus and a geometrical moment of inertia greater than a specified value.

The image recording method has no necessity of using a cylindrical recording drum and form an image on a non-flexible sheet member by forming an image in an image transfer sheet superposed on the non-flexible sheet member and peeling the image transfer sheet from the non-flexible sheet member. Accordingly, the image recording method enables forming a high quality of image even on non-flexible record sheet members such as tiles, stone plates and ceramic plates, metal plates or sheets, etc. that are too rigid to be bent.

The image recording method makes it possible to form a color filter of, for example, a liquid crystal display device by using different image transfer sheets having red, green and blue image forming layers, respectively. The use of the image transfer sheets peculiar to each color enables the color stripes to have a uniform color tone. It is desirable for the process of forming a color filer to form black stripes or a black matrix after having formed the red, green and blue stripes. In this instance, the color filter with black stripes can comprise the black, red, green and blue stripes each of which are uniform in color tone and is precise in optical characteristics. Further, in this instance, it is quite easy to form the black stripes so as to overlap the red, green and blue stripes with the intention of reliably preventing the color filter from an escape of light at borders of the color stripes.

The non-flexible sheet member may have an image receiving layer on the image forming surface. Otherwise, the image receiving layer may be formed by laying an image receiving sheet having an image receiving layer supported on a base sheet on the non-flexible sheet member, adhering the image receiving layer to the non-flexible sheet member and peeling the base sheet from the non-flexible sheet member so as thereby to transfer the image receiving layer to the non-flexible sheet member as the image forming surface.

The use of an image receiving later formed on or adhered to the non-flexible sheet member improves image transferability from the image transfer sheet to the non-flexible sheet member and simplifies the recording process.

The image receiving sheet laid on the non-flexible sheet member is preferably heated and pressed against the non-flexible sheet member by, for example, a heat roller so as thereby to bring the image receiving layer into tight adhesion to the image forming surface of the non-flexible sheet member. In this instance, the image receiving layer is firmly adhered to the non-flexible sheet member with a higher degree of adhesion.

The non-flexible sheet member is held from the back opposite to the image forming surface by, for example, suction pads so as to be fed with the image recording surface down and turned over when it is laid on the scanning stage. After having formed an image, the non-flexible sheet member is lifted up and held from the back opposite to the image formed surface by the suction pads and then removed from the scanning station. The non-flexible sheet member is turned over during removal from the scanning station and stacked on a collection device. This prevents the image recorded surface of the non-flexible sheet member from dusts and scratches and makes the image scanning station simple in structure.

The image transfer sheet is scanned by repeating one-way line scanning or, otherwise, by repeating bi-directional line scanning. The one-way line scanning is performed by making liner movement of the scanning head projecting the laser spot relative to the non-flexible sheet member from one end to another end of the image transfer sheet in a primary scanning direction for and reverse liner movement of the scanning head projecting no laser spot relative to the image transfer sheet in the primary scanning direction simultaneously with movement of the scanning head projecting no laser spot relative to the image transfer sheet in a secondary scanning direction perpendicular to the primary direction. The bi-directional line scanning is performed by making liner movement of the scanning head projecting the laser spot relative to the image transfer sheet from one end to another end of the image transfer sheet in the primary scanning direction, movement of the scanning head projecting no laser spot relative to the image transfer sheet in the secondary scanning direction perpendicular to the primary scanning direction and then reverse liner movement of the scanning head projecting the laser spot relative to the non-flexible sheet member between the opposite ends of non-flexible sheet member in the primary scanning direction.

The one-way line scanning makes it easy to control a starting point of scanning, so as to makes it hard to cause difference in image recording characteristics due to arrangement of a row of laser spots. On the other hand, the bi-directional line scanning can save scanning time significantly as compared with the one-way linear scanning.

The object of the present invention is also accomplished by an image forming apparatus for forming an image on a non-flexible sheet member having an image forming surface that is fixedly placed in a recording position by the use of an image transfer sheet having a photo-thermal conversion layer and an image forming layer. The image forming apparatus comprises: a table for supporting the non-flexible sheet member thereon; image transfer sheet feed means for feeding and laying the image transfer sheet on the non-flexible sheet member; a pressure roller operative to press the image transfer sheet so as to being the image forming layer into tight adhesion to the image recording surface of the non-flexible sheet member; scanning means for scanning the image transfer sheet from the back with a plurality of laser spots so that only areas of the image forming layer affected by heat developed in the photo-thermal conversion layer correspondingly to a pattern of exposure to the laser spots are fused to the image recording surface of the non-flexible sheet member; and peeling means for peeling the image transfer sheet from the non-flexible sheet member so as thereby to form a positive reproduction of the image on the non-flexible sheet member.

According to the image recording apparatus, the process of forming an image on a non-flexible sheet member is performed by a sequential operation of the scanning stage, the image transfer sheet deed means, the pressure roller, the scanning head and the peeling means in this order.

In the case of using the image receiving sheet, the image recording apparatus is provided with image receiving sheet feed means for feeding and laying the image receiving sheet on the non-flexible sheet member.

The image forming apparatus may further comprises non-flexible sheet member feed means for picking up an uppermost non-flexible sheet member from a stack of a plurality of non-flexible sheet members and carrying and laying the uppermost non-flexible sheet member onto the scanning stage and non-flexible sheet member removal means for removing the non-flexible sheet member formed with the image from the scanning stage. This makes it possible to perform image forming of a number of the non-flexible sheet members successively.

The laser spots are preferably arranged in a straight row inclined with respect to the primary and the secondary scanning direction perpendicular to each other so that a foremost laser spot in the primary scanning direction is positioned ahead of a foremost laser spot in the secondary scanning direction as viewed in the primary scanning direction.

This arrangement of laser spots Sp forces gas produced locally at a scanned point toward the lower reaches in the secondary scanning direction. This prevents the gas from staying between the image forming layer of the image transfer sheet and the image receiving layer of the non-flexible sheet member.

The scanning stage is formed with a recess defined by side walls. The recess has a depth substantially equal to a thickness of the non-flexible sheet member and an area greater than an area of the non-flexible sheet member so as to receive the non-flexible sheet member with an allowance left between the non-flexible sheet member and the wall in each of crosswise and lengthwise directions. This scanning stage can always support the image recording medium, i.e. the image transfer sheet and the image receiving sheet, flat without causing it to bend and/or crinkle even when the image recording medium has an area greater than the non-flexible sheet member.

Further, the recess may have a length and a width slightly greater than the length and the width of the non-flexible sheet member so as to provide a slight allowance in each of the crosswise direction and the lengthwise direction. In this instance, The scanning stage is provided with offset means installed in each of the side walls adjacent to each other for urging and offsetting the non-flexible sheet member against the side wall opposite to the each the side wall. This scanning stage realizes a simple mechanism for positioning the non-flexible sheet member in both primary and secondary scanning directions.

The scanning stage may be further provided with lift means for supporting and lifting up the non-flexible sheet member from the recess. The lift means comprises a plurality of lift pins installed to a bottom of the recess of the scanning stage so as to protrude from and retract in the bottom of the recess. When the non-flexible sheet member is carried above the scanning stage, the lift pins protruding from the bottom of the recess support the non-flexible sheet member away from the bottom of the recess, so that the suction pads holding the non-flexible sheet member are allowed to take a position between the non-flexible sheet member and the scanning stage. Further, after having formed an image on the non-flexible sheet member, the lift pins protrude from the bottom of the recess so as thereby to lift up the non-flexible sheet member, so that the suction pads are allowed to take a position between the non-flexible sheet member and the scanning stage and attract the non-flexible sheet member from the back opposite to the image formed surface.

The peeling means may comprise a plurality of peeling claws and socket grooves formed in the wall of the recess of the scanning stage. The peeling claws are moved into the socket grooves, respectively, and then lifted upward so as to lift up and peel the image recording medium, i.e. the image receiving sheet or the image transfer sheet, from the non-flexible sheet member. The socket groove makes it easy and reliable to enter between the image recording medium and the non-flexible sheet member. Accordingly, the recording medium is peeled easily from the non-flexible sheet member by means of a simple peeling mechanism.

### BRIEF DESCRIPTION OF THE DRAWINGS

The above and other object and features of the present invention would be understood more clearly from the following description when reading with reference to the accompanying drawings, in which:

FIG. 1 is a schematic illustration showing an image recording apparatus according to an embodiment of the present invention;

FIG. 2 is a cross-sectional view of a non-flexible sheet member;

FIG. 3 is a schematic constructional view of the image recording apparatus;

FIG. 4 is a perspective view of the non-flexible sheet member supported on support pins in a feeder device;

FIG. 5 is an explanatory view of relative movement between a scanning stage and a scanning head;

FIGS. 6A and 6B are explanatory views showing the steps of holding and carrying the non-flexible sheet member;

FIG. 7 is a cross-sectional view of the scanning stage with lift pins protruded from a bottom of a recess of the scanning stage;

FIG. 8 is a plan view of the scanning stage that holds the non-flexible sheet member in the recess;

FIG. 9 is a cross-sectional view of the scanning stage that holds the non-flexible sheet member in the recess;

FIG. 10 is a schematic constructional view of an essential part of the image recording apparatus including a sheet feeder arrangement and a scanning arrangement;

FIG. 11 is a cross-sectional view of an image transfer sheet that is superposed on an image receiving sheet;

FIG. 12 is an enlarged perspective view of a peeling mechanism;

FIGS. 13A, 13B and 13C are explanatory views showing peeling operation;

FIG. 14 is a cross sectional view of the scanning stage with the image transfer sheet attracted;

FIG. 15 is a perspective view showing relative movement between the scanning head and the non-flexible sheet member for scanning;

FIG. 16 is an explanatory illustration showing the positional relationship between the stationary scanning head in a fixed scanning position and the scanning stage in a starting position;

FIG. 17 is an explanatory view showing a row of laser spots;

FIG. 18 is an enlarged explanatory view of the scanning head;

FIG. 19 is illustrations showing steps of forming a black stripes on the non-flexible sheet member;

FIG. 20 is a diagram showing a one-way line scanning method;

FIG. 21 is an explanatory view showing the one-way line scanning at the beginning of first line scanning;

FIG. 22 is an explanatory view showing the one-way line scanning completely at the end of first line scanning;

FIG. 23 is an explanatory view showing the one-way line scanning on the way of second line scanning;

FIG. 24 a diagram showing a bi-directional line scanning method;

FIGS. 25A and 15B are diagrams showing variations of the one-way line scanning method and the bi-directional line scanning method, respectively;

FIG. 26 is a cross-sectional view of a color filter formed on the non-flexible sheet member; and

FIG. 27 is a schematic constructional view of a prior art image recording apparatus.

### DETAILED DESCRIPTION OF THE PREFERRED EMBODIMENT

In the following description, the term “non-flexible sheet member” as used herein shall mean and refer to hard materials such as glass plates, tiles, stones and ceramics and metals having hardness or thickness that is impossible to be bent within an elastic region. A soft recording material supported on a non-flexible sheet member is also called a non-flexible sheet member.

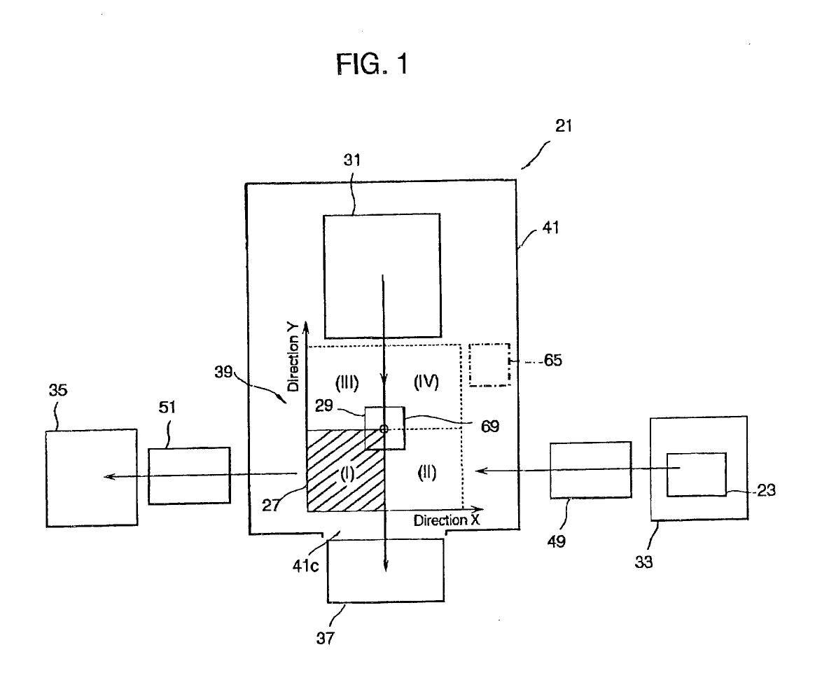

Referring to the drawings in detail, and, in particular, to FIG. 1 showing a conceptual structure of a recording apparatus 21 of the present invention, the recording apparatus 21 has main internal components including a movable scanning stage 27, a stationary scanning head 29 and the sheet feeder arrangement 31 in addition to a pressure roller and a peeling mechanism. The scanning stage 27 holds a non-flexible sheet member 23 having a recording surface 23a thereon on which an image is transferred and is movable in a plane in parallel to the recording surface 23a. The stationary scanning head 29 is movable between the home position 65 and a starting position 69 and projects laser beams so as to form a plurality of spots focused on the recording surface 23a of the non-flexible sheet member 23. The sheet feeder arrangement 31 feeds a recording medium (which will be described later), an image receiving sheet or an image transfer sheet, onto the non-flexible sheet member 23 on the scanning stage 27. A recording medium is pressed down on the non-flexible sheet member 23 by the pressure roller that will be described in detail later and peeled from the non-flexible sheet member 23 by means of the peeling mechanism such as comprising a pressure roller, peeling claws and socket grooves.

In addition to these main internal components, the recording apparatus 21 has main external components including a feed device 33 on which a stack of non-flexible sheet members are placed, a feed carrier mechanism 49 operative to carry the non-flexible sheet member 23 from the feed device 33 onto the scanning stage 27 in a lengthwise direction X, a removal carrier mechanism 51 operative to remove the non-flexible sheet member 23 with an image transferred thereto out of the recording apparatus 21 from the scanning stage 27 in the lengthwise direction X, and a collection device 35 on which the non-flexible sheet member 23 carried out of the recording apparatus 21 by the removal carrier mechanism 51 is placed and stacked. A waste box 37 is used to receive waste recording mediums after use.

The recording apparatus 21 is preferably provided with a laser shading frame 41 operative to blackout at least a scanning arrangement 39 including the stationary scanning head 29 and the sheet feeder arrangement 31 from a safety point of view, i.e. for the purpose of preventing laser leakage. The laser shading frame 41 is formed with an egress/ingress aperture 41a, 41b and 41c that can be opened and closed and through which the non-flexible sheet member 23 is carried in or out of the recording apparatus 21. In the case, in particular, where the recording apparatus 21 is used in order to form black stripes on a liquid crystal display devices or color filters for liquid crystal display devices, at least the recording apparatus 21 itself, the feed device 33 and the collection device 35 are installed in a clean room.

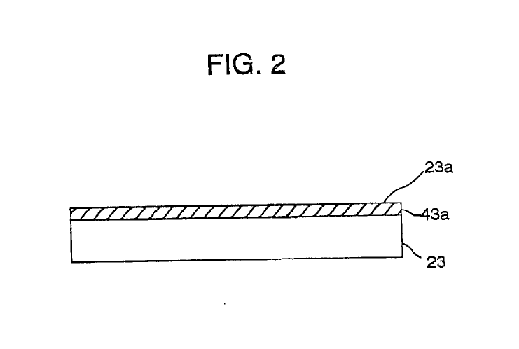

FIG. 2 shows a cross-section of one of available non-flexible sheet member 23. The non-flexible sheet member 23 is formed, if necessary, with a functional layer 43a, i.e. a toner image receiving layer, to which a toner layer (an image forming layer) is transferred. The non-flexible sheet member 23 formed with the functional layer 43a improves toner image transferability and simplifies the recording process. The following description will be directed to the recording method and apparatus of forming an image on the non-flexible sheet member 23 having no functional layer 43a such as an image receiving layer.

The flexibility of the non-flexible sheet member 23 is defined using a geometrical moment of inertia I and a longitudinal modulus (Young's modulus) E. The geometrical moment of inertia I, that is different depending upon shapes of cross-section, is expressed, in the case of a rectangle, by (width of cross-section)×([height of cross-section]³)/12. The longitudinal modulus E is given as a value peculiar to materials. In this instance, the flexibility of the non-flexible sheet member 23 is defined using the longitudinal modulus E and a value of (longitudinal modulus E×geometrical moment of inertia I). This value of (longitudinal modulus E×geometrical moment of inertia I) is what is called bending rigidity and depends upon the quality of material and the shape of cross-section. The bending rigidity means the degree of bending due to material and a shape (principally the thickness in this embodiment). Measurements were made of Young's modulus and bending rigidity in connection with polyethylene telephthalate (PET) sheets, foamed polyethylene telephthalate (foamed PET) sheets, polystyrene sheets, glass sheets, aluminium sheets and iron sheets and the measured values are shown together with the result of mounting suitability assessment in the following table.

| | | | | Geometrical | | |
|---|---|---|---|---|---|---|
| | Young's | | | Moment of | Bending | |
| | Modulus | Thickness | | Inertia | Rigidity | Mounting |
| Material | [Gpa] | [mm] | Width [mm] | [mm4] | [Nm2] | Suitability |
| PET | 4.9 | 0.1 | 300 | 0.025 | 123 | Good |
| PET | 4.9 | 0.1 | 1000 | 0.083 | 408 | Good |
| PET | 4.9 | 0.2 | 300 | 0.134 | 657 | No Good |
| PET | 4.9 | 0.2 | 1000 | 0.447 | 2188 | No Good |
| PET | 4.9 | 0.2 | 300 | 0.200 | 980 | No Good |
| PET | 4.9 | 0.2 | 1000 | 0.667 | 3267 | No Good |
| PET | 4.9 | 0.3 | 300 | 0.675 | 3308 | No Good |
| PET | 4.9 | 0.3 | 1000 | 2.250 | 11025 | No Good |
| PET | 4.9 | 0.5 | 300 | 3.125 | 15313 | No Good |
| Foamed PET | 2.3 | 0.1 | 300 | 0.025 | 56 | Good |
| Foamed PET | 2.3 | 0.1 | 1000 | 0.083 | 188 | Good |
| Foamed PET | 2.3 | 0.1 | 300 | 0.055 | 124 | Good |
| Foamed PET | 2.3 | 0.1 | 1000 | 0.183 | 412 | Good |
| Foamed PET | 2.3 | 0.2 | 300 | 0.200 | 450 | Good |
| Foamed PET | 2.3 | 0.2 | 1000 | 0.667 | 1500 | No Good |
| Foamed PET | 2.3 | 0.5 | 300 | 3.125 | 7031 | No Good |
| Polystyrene | 3.5 | 0.1 | 1000 | 0.083 | 292 | No Good |
| Polystyrene | 3.5 | 0.5 | 1000 | 10.417 | 36458 | No Good |
| Glass | 71.3 | 0.1 | 1000 | 0.083 | 5942 | No Good |
| Glass | 71.3 | 0.2 | 1000 | 0.667 | 47533 | No Good |
| Glass | 71.3 | 0.5 | 1000 | 10.417 | 742708 | No Good |
| Glass | 71.3 | 0.5 | 300 | 3.125 | 222813 | No Good |
| Glass | 71.3 | 0.8 | 1000 | 42.667 | 3042133 | No Good |
| Glass | 71.3 | 1.0 | 300 | 25.000 | 1782500 | No Good |
| Glass | 71.3 | 1.0 | 1000 | 83.333 | 5941677 | No Good |
| Glass | 71.3 | 1.2 | 300 | 43.200 | 3080160 | No Good |
| Glass | 71.3 | 1.2 | 1000 | 144.000 | 10267200 | No Good |
| Glass | 71.3 | 1.5 | 300 | 84.375 | 6015938 | No Good |
| Glass | 71.3 | 1.5 | 1000 | 281.250 | 20053125 | No Good |
| Aluminium | 70.3 | 0.1 | 1000 | 0.083 | 5858 | No Good |
| Aluminium | 70.3 | 0.2 | 1000 | 1.152 | 80986 | No Good |
| Aluminium | 70.3 | 0.5 | 1000 | 10.417 | 732292 | No Good |
| Metal | 152.3 | 0.1 | 1000 | 0.083 | 12692 | No Good |
| Metal | 152.3 | 0.5 | 1000 | 10.417 | 1586458 | No Good |

The mounting suitability was assessed by mounting the sheet on a drum having a diameter of 380 mm.

It is proved from the above table that the Young's modulus E is 4.9 Gpa for the PET sheets, 2.25 GPa for the formed PET sheets, 3.35 Gpa for the polystyrene sheets, 71.3 Gpa for the glass plates, 70.3 Gpa for the aluminium sheets and 152.3 Gpa for the metal sheets and that it becomes impossible to mount the sheet on the drum when the thickness is larger than 0.1 mm (the bending rigidity: E×I=408) for the PET sheets, larger than 0.2 mm (the bending rigidity: E×I=450) for the formed PET sheets, and larger than 0.1 mm (the bending rigidity: E×I=292) for the polystyrene sheets.

The non-flexible sheet member 23 used in the present invention is such as to have a Young's modulus of larger than 10 Gpa and a bending rigidity E×I of larger than 500 Pam² by way of example.

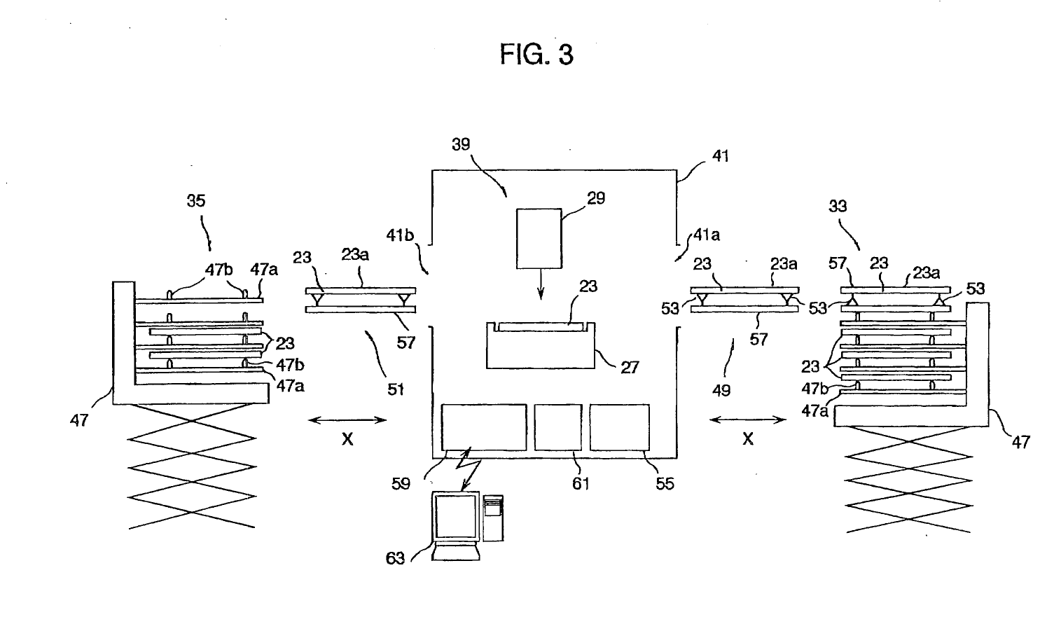

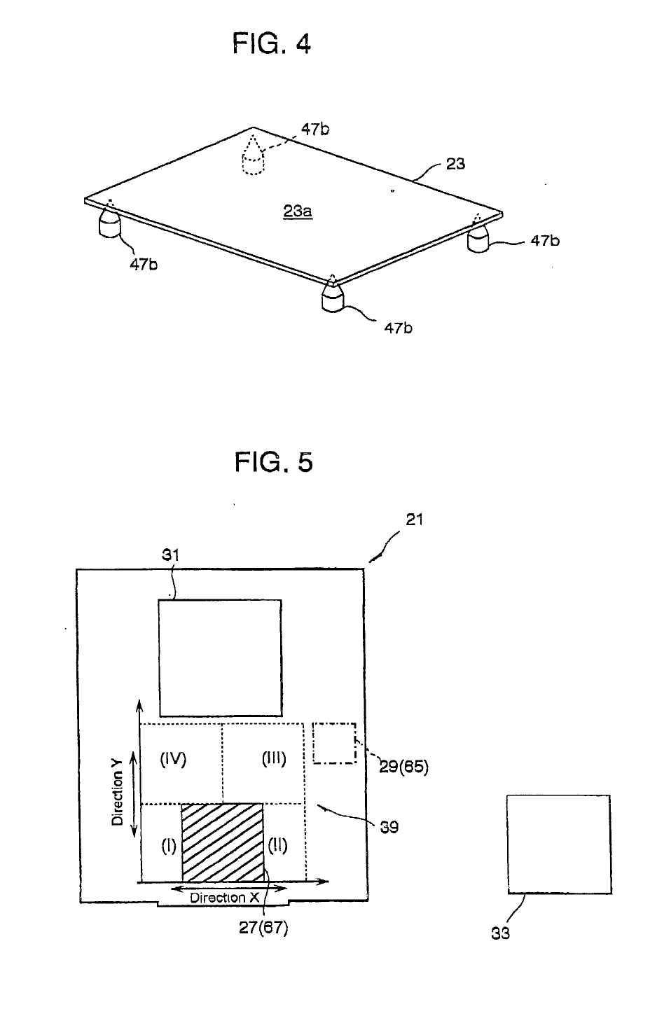

Referring to FIG. 3 showing an organization of the recording apparatus 21, the feed device 33 comprises a rack 47 on which a plurality of non-flexible sheet members 23 are stacked up at regular separations. The non-flexible sheet member 23 is ordinarily placed with the recording surface 23a down in order to prevent the recording surface 23a from gathering dust thereon. It is preferred to support the recording surface of the non-flexible sheet member 23 in point-contact so as to prevent alien substances from sticking to the recording surface 23a. For example, the point-contact support can be realized by the use of conical support pins 47b such as shown in FIG. 3 or, otherwise, ball point support pins. In the case where the non-flexible sheet member 23 is rectangular, at least four support pins 45 are located correspondingly to four corners of the non-flexible sheet member 23. The number of support pins may be increased according to size and/or bending rigidity of the non-flexible sheet member 23.

Specifically, the rack 47 has a plurality of shelves 47a fixedly attached to the rack 47 at regular vertical separations. The four support pins 47b are arranged on each of the shelves 47a. The rack 47 is lifted up and down by a lift mechanism (not shown) so as to adjust an uppermost non-flexible sheet member 23 to a specified vertical position. This lift mechanism may, for example, control a vertical position of the uppermost non-flexible sheet member 23 by detecting a weight or a thickness of one non-flexible sheet member 23 and lifting up the rack 47 by a specified vertical distance every time one non-flexible sheet member 23 is removed from the rack 47 or by detecting a vertical position of the uppermost one of a stack of non-flexible sheet members 23 and lifting up or down the rack 47 so as to adjust the uppermost non-flexible sheet member 23 to the specified vertical position.

The feed carrier mechanism 49 is disposed between the feed device 33 and the scanning stage 27, and the removal carrier mechanism 51 is disposed between the scanning stage 27 and the collection device 35. Each of these feed carrier mechanism 49 and removal carrier mechanism 51 has a carrier table 57 equipped with vacuum type suction pads 53 mounted on the carrier table 57 that are operative to firmly hold the non-flexible sheet member 23. There are provided at least three, more desirably four, suction pads 53. The number of suction pads 53 may be increased or decreased according to a shape of the non-flexible sheet member 23. Each suction pad 53 is connected to a source of suction 55 such as a suction pump and a suction blower through an air duct (no shown). The carrier table 57 of each of the feed carrier mechanism 49 and the removal carrier mechanism 51 is moved back and force between the scanning stage 27 and the feed carrier mechanism 49 or the removal carrier mechanism 51 by a drive engine such as an electric motor, an air cylinder, a hydraulic cylinder and the like and is guided on guide rails or guide slots. A linear motor mechanism or a robot manipulator that is equipped with suction pads, a source of suction, guide rails or slots and the like all of which are united as one whole may be used in place of each of the feed carrier mechanism 49 and the removal carrier mechanism 51.

The recording apparatus 21 is further provided with an image forming circuit operative to control the stationary scanning head 29, a controller 59 operative to control drive motors for the stationary scanning head 29 and the scanning stage 27, respectively, the feed carrier mechanism 49, the removal carrier mechanism 51, the source of suction 55 and the like, and an electric source 61 operative to supply electric power to the controller 59, the source of suction 55 and the drive motors. The recording apparatus 21, in particular the controller 59, is connected to a host computer 63 by means of a communication line so as to transmit and receive control signals necessary to perform image forming control and control of feeding and removing the non-flexible sheet member 23.

Referring to FIG. 5 showing operation of a scanning mechanism 39 that comprises the scanning stage 27 and the stationary scanning head 29, in an initial state of the scanning mechanism 39, the stationary scanning head 29 is in a home or standby position 65 away from the scanning stage 27 and, on the other hand, the scanning stage 27 is in a feed/removal position 67. In this instance, the scanning arrangement 39 is located with its center aligned with a fixed scanning position 69 which is coincide with a center of the stationary scanning head 29 fixedly positioned during recording (see FIG. 1). The scanning stage 27 has a field of movement comprising first to fourth quadrants each of which has the same area as the scanning stage. In other words, the scanning stage 27 is moveable a distance two times as long as the length thereof in the lengthwise direction X and a distance tow times as long as the width thereof in the crosswise direction Y. Accordingly, the stationary scanning head 29 in the recording position can scan all points on the scanning stage 27.

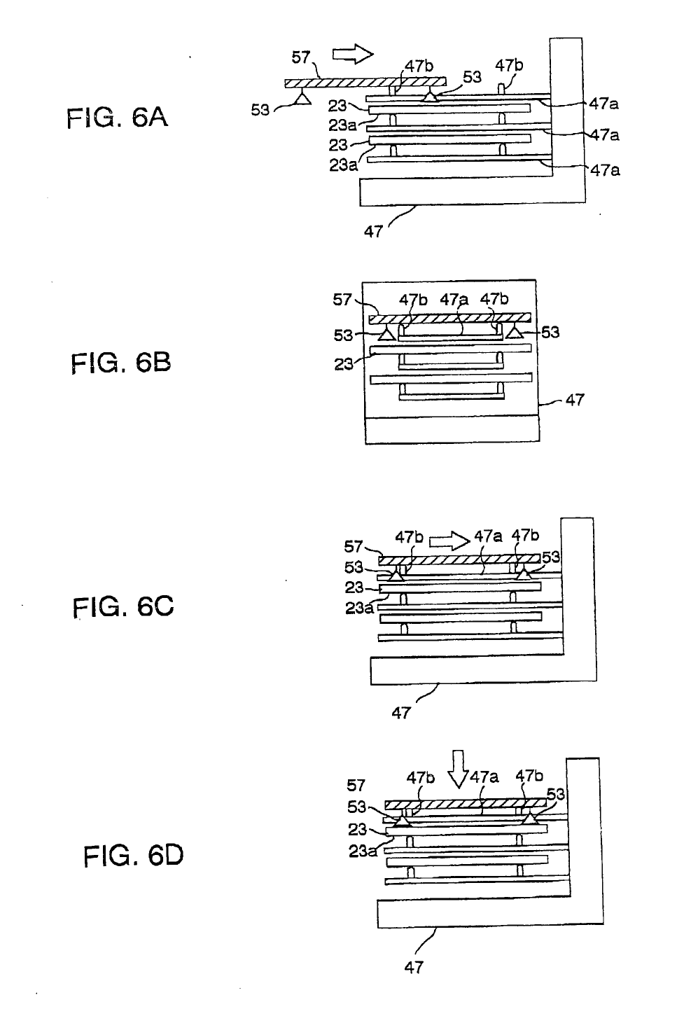

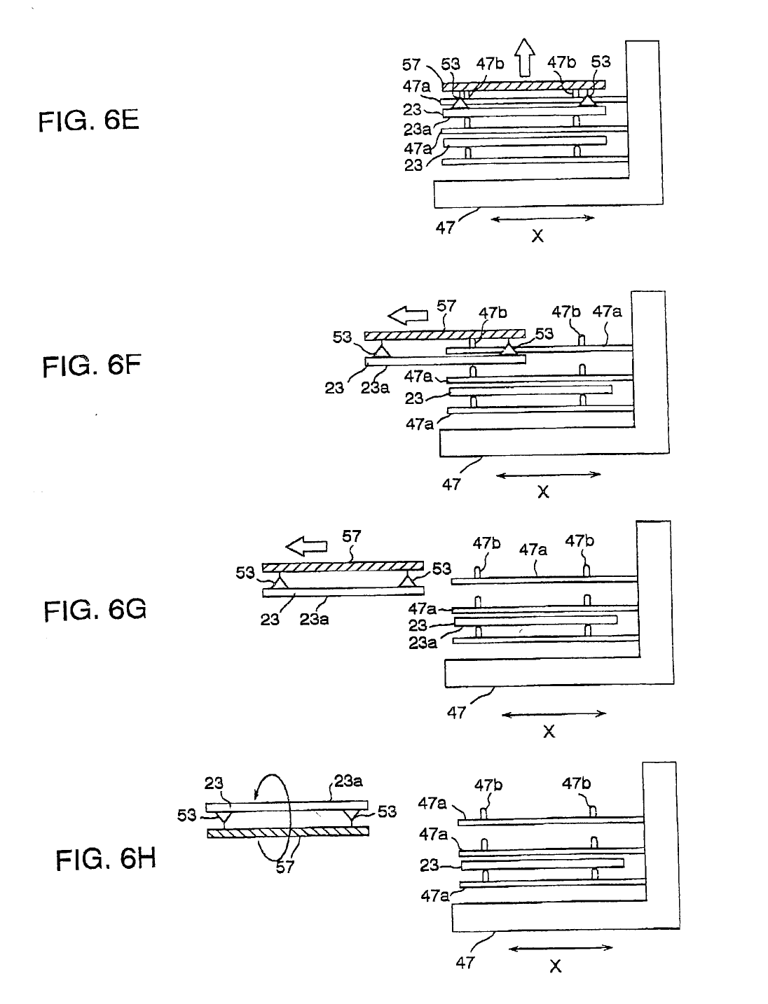

FIGS. 6A through 6H show a process of picking up and carrying the non-flexible sheet member 23 from the feed device 33. As shown in FIG. 6A, the feed carrier mechanism 49 moves the carrier table 57 in a horizontal plane in a lengthwise direction X toward the rack 47 of the feed device 33. As shown in FIG. 6B, the shelf 47a is provide with support pins 45 at front and rear ends. The width of the shelf 47a, and hence the crosswise distance (the distance in the crosswise direction Y) between the support pins 45, is smaller than the width of the non-flexible sheet member 23 and the crosswise distance between the suction pads 53 of the carrier table 57. The carrier table 57 is stopped when reaches a pickup position right above the uppermost non-flexible sheet member 23 supported on the shelf 47a of the rack 47 of the feed device 33 as shown in FIG. 6C, then the carrier table 57 is lowered until the suction pads 53 come into contact with the non-flexible sheet member 23 as shown in FIG. 6D and, then, the carrier table 57 is stopped by, for example, detecting a specified reactive pressure against the suction pads 53.

Subsequently, the source of suction 55 is activated to as to cause the suction pads 53 to attract the non-flexible sheet member 23. After keeping the carrier table 57 stopped until the degree of vacuum in the inside of each suction pad 53 reaches a specified degree, the carrier table 57 holding the non-flexible sheet member 23 is lifted up as shown in FIG. 6E. At this time, the non-flexible sheet member 23 is attracted at the back opposite to the image recording surface 23a by the suction pads 53, so that the image recording surface 23a is free from suction marks. The carrier table 57 holding the non-flexible sheet member 23 is moved toward the scanning stage 27 of the image recording apparatus 21 in the lengthwise direction X as shown in FIG. 6F.

On the way toward the scanning stage 27, the carrier table 57 holding the non-flexible sheet member 23 is temporarily stopped before the ingress aperture 41a of the laser shielding frame 41 as shown in FIG. 6G, then, the carrier table 57 holding the non-flexible sheet member 23 is turned over as shown in FIG. 6h, so as thereby to turn the image recording surface 23a of the non-flexible sheet member 23 up. Thereafter, the carrier table 57 holding the non-flexible sheet member 23 is moved to the scanning stage 27 through the ingress aperture 41a of the laser shielding frame 41.

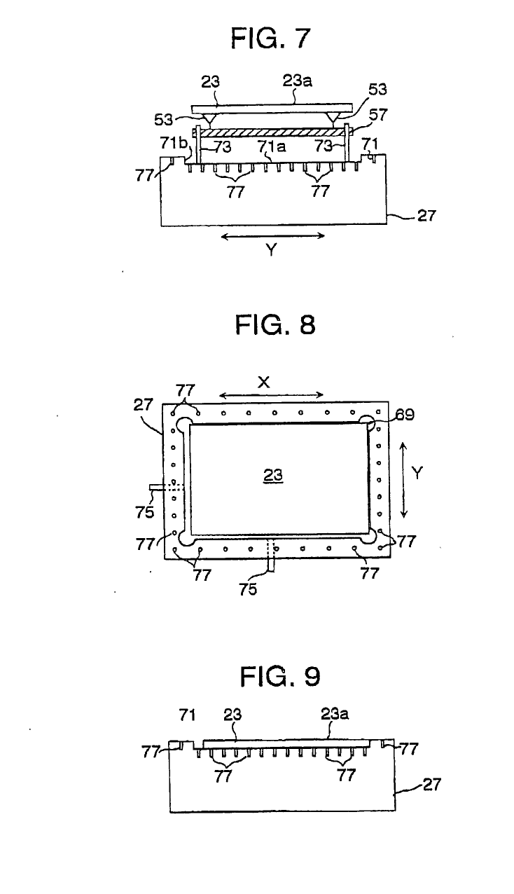

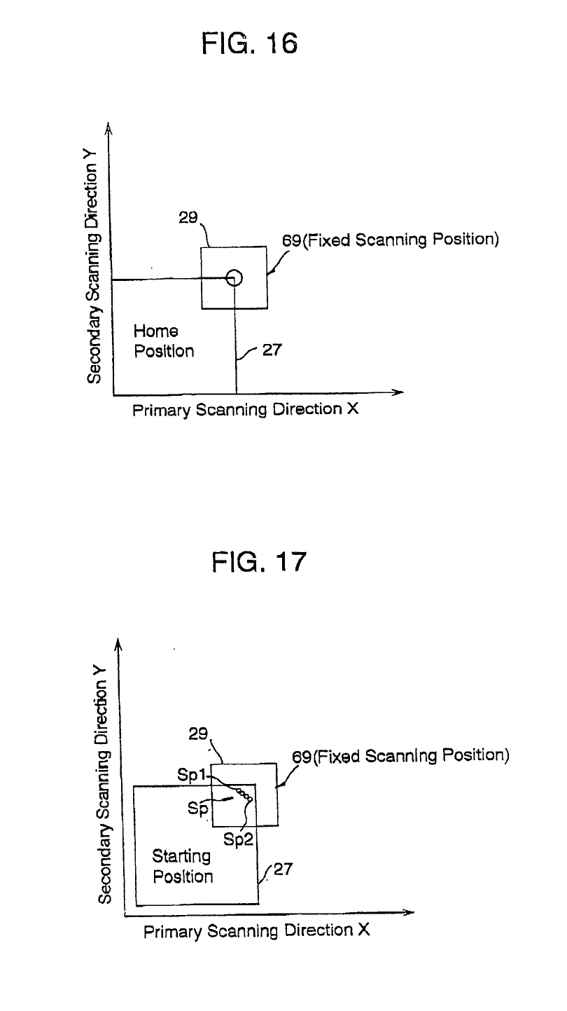

Referring to FIGS. 7 to 9, the scanning stage 27 is formed in the top thereof with a rectangular recess 71 for receiving the non-flexible sheet member 23. The recess 71 is finished by, for example, milling to a depth substantially equal to the thickness of the non-flexible sheet member 23 and a length and a width slightly greater than the length and the width of the non-flexible sheet member 23 so as to provide a slight allowance in each of the crosswise direction Y and the lengthwise direction X as shown in FIG. 8. The scanning stage 27 is equipped with a positioning mechanism that comprises lift pins 73 installed in the bottom 71a of the recess 71 and offset pins 75 installed in two side walls 71b adjacent to each other. The lift pins 73 support and lift up and down the non-flexible sheet member 23. The offset pins 75 bias the non-flexible sheet member 23 against other two side walls adjacent to each other 71b. Further, the scanning stage 27 is formed with a number of suction nozzles 77 arranged in the bottom 71a and the side walls 71b of the recess 71. These suction nozzle 77 lead to a suction air passage (not shown) connected to the source of suction 55. The suction nozzles 77 arranged in the bottom 71a of the recess 71 are used to suck air between the non-flexible sheet member 23 and the bottom 71a of the recess 71 of the scanning stage 27 so as thereby to firmly attract the non-flexible sheet member 23 onto the bottom 71a of the recess 71. The suction nozzles 77 arranged in the side walls 71b are used to suck air so as thereby to firmly attract a recording medium (which will be described later) such as an image transfer sheet 105 onto the side walls 71b of the recess 71 (see FIG. 16).

The feed carrier mechanism 49 moves the carrier table 57 into the interior of the recording apparatus 21 through the ingress aperture 41a of the laser shielding frame 41 until the carrier table 57 reaches above the scanning stage 27 and further lowers the carrier table 57 down until the non-flexible sheet member 23 comes into contact with the lift pins 73 as shown in FIG. 7. The feed carrier mechanism 49 may includes a pressure sensor that can detect a reactive pressure acting on the suction pads 53 when the non-flexible sheet member 23 comes into contact with the lift pins 73 and stops the carrier table 57 when the pressure sensor detects a specified pressure. Otherwise, the feed carrier mechanism 49 may includes a distance sensor that can detect a distance of movement of the carrier table 57 and stops the carrier table 57 when the distance sensor detects a specified distance of movement of the carrier table 57. The feed carrier mechanism 49 opens the air duct to the atmosphere so as thereby to cause the suction pads 53 to release the non-flexible sheet member 23 so as to lay the non-flexible sheet member 23 on the lift pins 73. After keeping the carrier table 57 stopped until the degree of vacuum in the inside of each suction pad 73 reaches a specified degree or the atmospheric pressure, the feed carrier mechanism 49 moves back the carrier table 57 out of the recording apparatus 21 through the egress/ingress aperture 41a of the laser shielding frame 41. On the other hand, the positioning mechanism retracts the lift pins 73 until the non-flexible sheet member 23 is laid on the bottom 71a of the recess 71, and then protrudes the offset pins 75 so as to move the non-flexible sheet member 23 in both lengthwise and crosswise directions X and Y until bringing it into abutment against the side walls 71b. As a result, the non-flexible sheet member 23 is located in a fixed position where one corner of the non-flexible sheet member 23 is placed at the fixed scanning position 69. Subsequently, the source of suction 55 is actuated and sucks air through the suction nozzles 77, so as thereby to firmly attract the non-flexible sheet member 23 onto the bottom 71a of the recess 71. In this way, the scanning stage 27 fixedly holds the non-flexible sheet member 23 in place in the recess 71. As shown in FIG. 16, since the recess 71 has a depth equal to the thickness of the non-flexible sheet member 23, the scanning stage 27 firmly attracts and holds a recording medium such as the image transfer sheet 105 and the image forming sheet 87 onto the side walls 71b of the recess 71 always flat without causing it to bend and/or crinkle even when the recording medium 87 or 105 has an area greater than the recess 71. This provides tight adhesion between the non-flexible sheet member 23 and a recording medium that is laid on the non-flexible sheet member 23. The recess 71 having the walls 71b that intersect perpendicularly to each other makes it quite easy to position the non-flexible sheet member 23 precisely in both lengthwise and crosswise directions X and Y although it is simple in structure. The lift pins 73 are separated in the crosswise direction Y sufficiently for the carrier table 57 to go back and forth between the lift pins 73 in the protruded position, so that the non-flexible sheet member 23 is supported at the back side opposite to the recording surface 23a thereof by the suction pads 53.

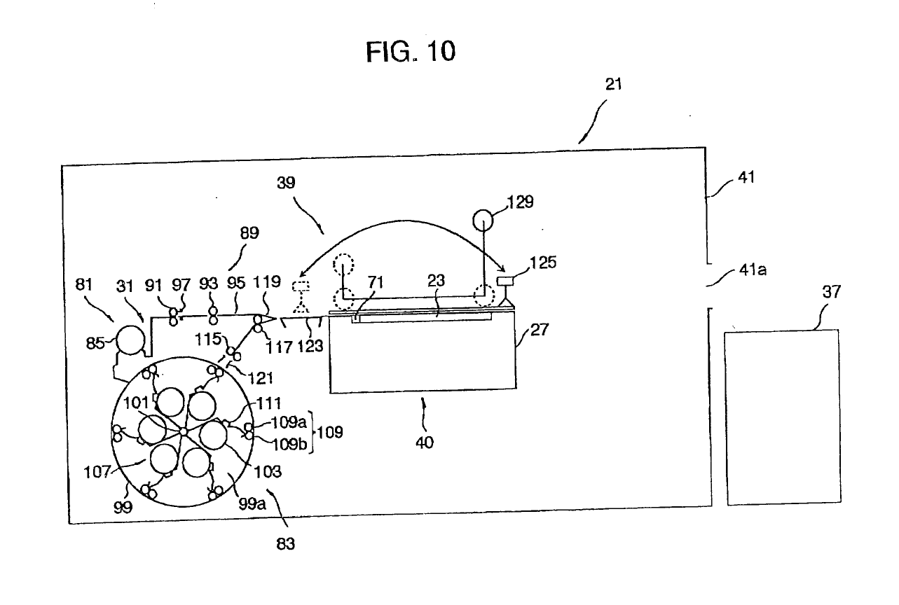

Referring to FIG. 10 showing the scanning arrangement 39 for recording an image on the non-flexible sheet member 23 held by the scanning stage 27, the scanning arrangement 39 includes a sheet feeder arrangement 31 that comprises an image receiving sheet feed device 81 and an image transfer sheet feed device 83. The image receiving sheet feed device 81 feeds an image receiving sheet 87 to a scanning station 40. The image transfer sheet feed device 83 can selectively feed a multiple types of image transfer sheets 105 to the scanning station 40.

Specifically, the image receiving sheet feed device 81 includes a roll of image receiving paper strip 85 wound around a spool, a conveyer system 89 and a sheet sensor (not shown). The conveyer system 89 comprises a pair of capstan rollers 91 operative to unwind the image receiving paper strip 85 off the roll, a paper cutter 97 operative to cut away the image receiving paper strip 85 into a specified length of image receiving sheet 87, a pair of feed rollers 93 operative to feed the image receiving sheet 87 to the scanning station 40 along a sheet guide 95. These components of the conveyer system 89 are driven by a motor and belt mechanism (not shown) so as to feed the image receiving sheet 87 to the scanning station 40. The paper cutter 97 is equipped with a sensor operative to detect directly a length of the image recording paper strip 95 pulled out from the roll or a sensor operative to detect a number of rotations of the capstan rollers 91 based on which a length of the image recording paper strip 95 pulled out is indirectly detected. The paper sensor detects a leading end of the image receiving sheet 87 fed to the scanning station 40. The roll of image receiving paper strip 85 can be replaced with another roll of image receiving paper strip 85 when used up entirely or if necessary.

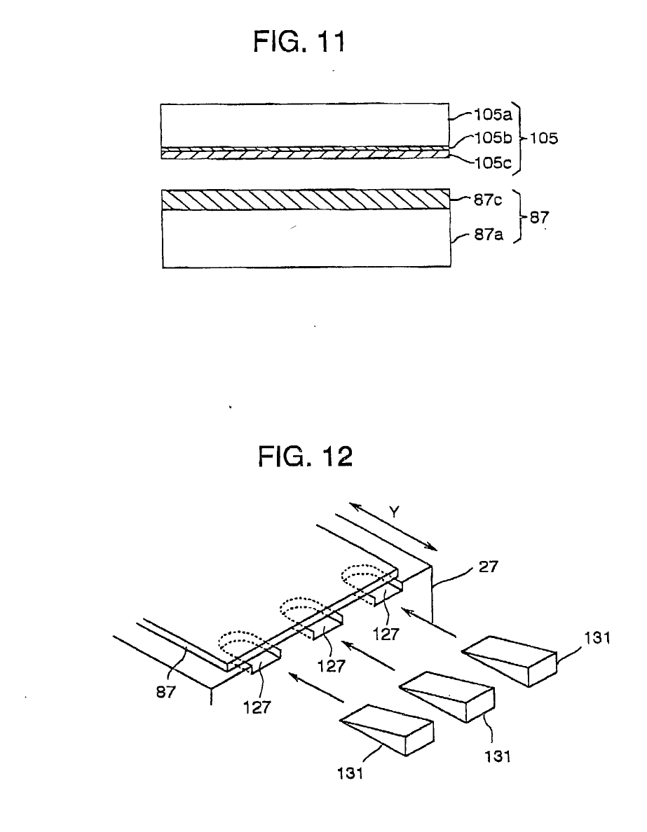

In this instance, as shown in FIG. 11, the image receiving paper strip 85 comprises a support 87a such as a polyethylene telephthalate (PET) base support, a triacetyl cellulose (TAC) base support, a polyethylene naphthalate base support, etc and an image receiving layer 87c formed on the support 87a. The image receiving layer 87c receives a toner image from an image transfer sheet.

The image transfer sheet feed device 83 comprises a rotary radial rack 99 mounted for rotation on a shaft 101, a conveyer system 113 and a sheet sensor (not show). The rotary radial rack 99 has a plurality of, for example six in this embodiment, roll chambers 99a arranged in radial directions and a plurality of paper delivery mechanisms 107, one for each roll chamber. The paper delivery mechanism 107 comprises a pair of capstan rollers 109, namely a capstan roller 109a, that is driven by a motor through a gear train described later, and a pinch roller 109b, to unwind the image transfer paper strip 103 off the roll and a paper guide 111. The roll chambers 99a receive a plurality of rolls of different image transfer paper strip 103, one in each chamber. Each roll of image transfer paper strip 103 is mounted on a spool. The image transfer papers strips 103 are different in color and include at least black, red, green and blue.

The conveyer system 113 comprises a pair of capstan rollers 115 operative to pull the image transfer paper strip 103 out of the roll chamber 99a, a paper cutter 121 operative to cut away the image transfer paper strip 103 into a specified length of image transfer sheet 105, a pair of feed rollers 119 operative to feed the image transfer sheet 105 to the scanning station 40 along a sheet guide 119. These components of the conveyer system 113 are driven by a motor and belt mechanism (not shown) so as to feed the image transfer sheet 105 to the scanning station 40. The paper cutter 97 is equipped with a sensor operative to detect directly a length of the image transfer paper strip 103 unwound from the roll or a sensor operative to detect a number of rotations of the capstan roller 109a based on which a length of the image transfer paper strip 103 unwound is indirectly detected. The paper sensor detects a leading end of the image transfer sheet 105 fed to the scanning station 40. In this way, the image transfer sheet feed device 83 selectively feed a desired color of image transfer sheet 105 to the scanning station 40.

The roll of image transfer paper strip 103 in each roll chamber 99a can be replaced with another roll of image transfer paper strip 103 when used up entirely or if necessary.

In this instance, as shown in FIG. 11, the image transfer paper strip 103 comprises a transparent support 105a, a photo-thermal conversion layer 105b formed on the transparent support 105a and a image forming layer or toner layer 105c formed over the photo-thermal conversion layer 105b. The transparent support 105a is made of any one of ordinary materials that transmit laser rays. For example, the support 105 may be made of the same material as used for the support 87a of the image receiving paper strip 85. The photo-thermal conversion layer 105b makes the function of converting laser energy to heat and can be made of any one of ordinary photo-thermal conversion materials such as carbon, black materials, infrared absorbing pigments, materials that can absorb particular wavelengths. There are various toner colors available for the toner layer 105c such as cyan (C), magenta (M) and yellow (Y) for printing and what is called special color such as gold, silver, orange, gray and pink in addition to black (K), red (R), green (G) and blue (B).

The image transfer paper strip 103 is wound in a roll with the toner layer 105c directed toward the outside with respect to the transparent support 105a.

The scanning arrangement 39 is provided with a sheet guide 123 before the scanning station 40 so as to guide an intermediate recording sheet, namely an image receiving sheet 87 or an image transfer sheet 105, fed by the sheet feeder arrangement 31, toward the scanning station 40. The sheet guide 123 is moved out of the path of sheet along which the an image receiving sheet 87 or the image transfer sheet 105 passes to the scanning station so as to be prevented from interfering with the scanning stage 27 when the scanning station 27 moves. There are provided a plurality of suction pads 125 arranged in line in the crosswise direction Y of the non-flexible sheet member 23 above the sheet guide 123. The suction pads 125 are connected to the source of suction 55 through air ducts (not shown) and lifted up and down and moved between opposite ends of the scanning stage 27 in the lengthwise direction X by a manipulator arm (not shown). The suction pads 125 are lowered so as to force down the image receiving sheet 87 against the sheet guide 123 and then attract the image receiving sheet 87. The suction pads 125 are lifted up and moved in the lengthwise direction X by the manipulator arm so as to position the image receiving sheet 87 just above the scanning stage 27. Subsequently, the suction pads 125 are lowered so as to lay the image recording sheet 87 on the top of the non-flexible sheet member 23 laid in the recess 71 of the scanning stage 27.

As shown in FIGS. 10 and 12, the scanning stage 27 is formed with socket grooves 127 in the side wall 71b of the recess 71 at an approach side from which the non-flexible sheet member 23 approaches the scanning stage 27. The sockets grooves 127 extend in the lengthwise direction X so as to be partly overlapped by the image receiving sheet 87 in tight adhesion with the non-flexible sheet member 23 in the recess 71 of the scanning stage 27. The socket grooves 127 receive wedge-shaped peeling claws 131, respectively. As will be described later, the peeling claws 131 received in the socket grooves 127 are lifted up to peel the image receiving sheet 87 from the non-flexible sheet member 23 attracting the bottom 71a of the recess 71 of the scanning stage 27.

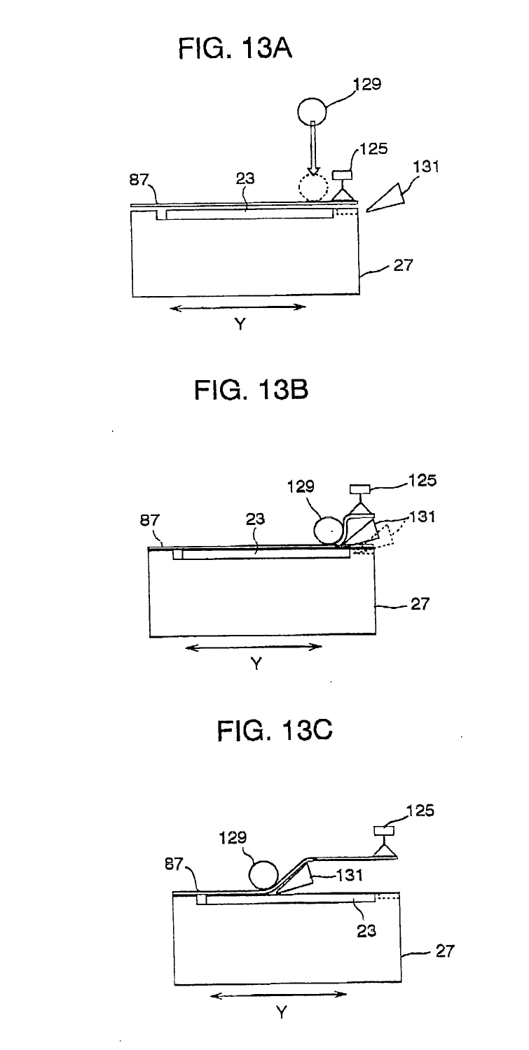

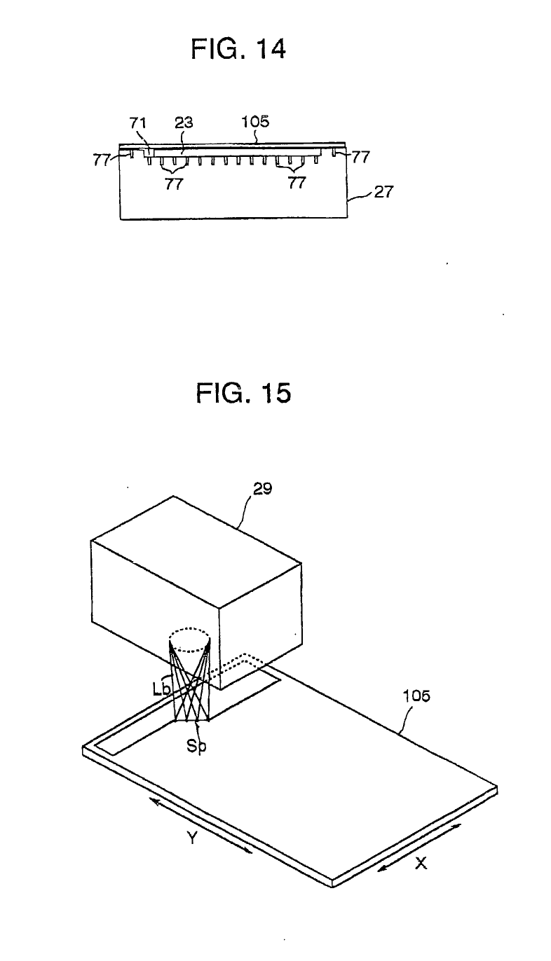

As shown in FIGS. 13A, 13B and 13C, the scanning arrangement 39 is further provided with a pressure roller 129 that is movable up and down and in the lengthwise direction X so a to operate as both squeeze roller and backup roller. When operating as the squeeze roller, the pressure roller 129 is lowered down to press leading part of the image receiving sheet 87 lying down on the non-flexible sheet member 23 against the scanning stage 27 and then rolled pressing it down against the non-flexible sheet member 23 to an end of the scanning stage 27 opposite to the approach side so as thereby to smooth out the image recording sheet 87. Besides the pressure roller 129, the scanning arrangement 39 may be provided with a heat roller as subsidiary squeezing means that is rolled heating and pressing the image receiving sheet 87 down against the non-flexible sheet member 23 so as to bring the image receiving sheet 87 into tight adhesion with the non-flexible sheet member 23 with a higher degree of adhesion as compared with using the pressure roller 129 only. The pressure roller 129 may be replaced with the heat roller.

The pressure roller 129 is used as the backup roller during peeling the image receiving sheet 87 from the non-flexible sheet member 23 that is fixedly attracted to the bottom 71a of the recess 71 of the scanning stage 27. Specifically, the pressure roller 129 is lowered down to press the leading part of the image receiving sheet 87 behind the suction pads 125 as shown in FIG. 13A. After lifting the suction pads 125 slightly upward, the peeling claws 131 are moved in the lengthwise direction X so as to enter the socket grooves 127 and then lifted and inclined slightly upward to a position where the peeling claws 131 are free from interference with the non-flexible sheet member 23 and the scanning stage 27 as shown in FIG. 13B. While keeping the pressure roller 129 and the peeling claws 131 in the relative position, the scanning stage 27 with the image receiving sheet 87 and the non-flexible sheet member 23 remaining united to the scanning stage 27 is moved away from the sheet feeder arrangement 31 in the crosswise direction Y as shown in FIG. 13C. As a result, the peeling claws 131 holds the image receiving sheet 87 against the pressure roller 129 during lengthwise movement of the scanning stage 27, so as to gradually peel the image receiving sheet 87 from the non-flexible sheet member 23 as the scanning stage 27 moves in the lengthwise direction X. At this time, the image receiving layer 87c of the image receiving sheet 87 is left tightly adhered to the non-flexible sheet member 23, so as to be transferred to the non-flexible sheet member 23. The suction pads 125 holding the image receiving sheet 87 without the image receiving layer 87c, i.e. the support 87a, is moved out of the laser shading frame 41 through the egress aperture 41c and through away into the waste box 37. The scanning arrangement 39 may be provided with an exclusive backup roller separately from the pressure roller 129 used as the squeeze roller.

The image transfer sheet 105 is laid on the top of the non-flexible sheet member 23 received in the recess 71 like the image receiving sheet 87. That is, when the image transfer sheet 105 is selectively fed onto the sheet guide 123, the suction pads 125 are lowered so as to force down the image transfer sheet 105 against the sheet guide 123 and then attract the image transfer sheet 105. The suction pads 125 are lifted up and moved in the lengthwise direction X by the manipulator arm so as to position the image transfer sheet 105 just above the scanning stage 27. Subsequently, the suction pads 125 are lowered so as to lay down the image transfer sheet 87 on the top of the non-flexible sheet member 23 with the image receiving layer 87c received in the recess 71 of the scanning stage 27.

The image transfer sheet 105 desirably has a surface area greater than an aperture area of the recess 71 of the scanning stage 27 and is fixedly attracted to the walls 71b of the recess 71 of the scanning stage 27 by sucking air between the image transfer sheet 105 and the walls 71b of the recess 71 of the scanning stage 27. After laying the image transfer sheet 105 on the non-flexible sheet member 23, an image is recorded on the image transfer sheet 105 by scanning the image transfer sheet 105 from the back with the stationary scanning head 29.

FIGS. 15 to 18 illustrate how the image transfer sheet 105 is scanned. A scan, in particular a serial scan, can be performed by moving either one of the stationary scanning head 29 and the scanning stage 27 relatively to another or by moving both stationary scanning head 29 and scanning stage 27 in opposite directions, respectively. The following description will be directed to the case of performing a serial scan of the image transfer sheet 105 by moving the scanning stage 27 relative to the stationary scanning head 29 that is fixedly positioned. As shown in FIG. 15, in order to scan the image transfer sheet 105, the stationary scanning head 29 projects laser beams Lb so as to form laser spots Sp in a row on the image transfer sheet 105 and is moved in a primary scanning direction (the crosswise direction Y) and a secondary scanning direction (the lengthwise direction). As shown in FIG. 16, when entering into scanning, the scanning stage 27 is moved to a predetermined starting position where it brings the specific corner of the non-flexible sheet member 23 into coincidence with the fixed scanning position 69 from the home position 65 and then fixed in the scanning position.

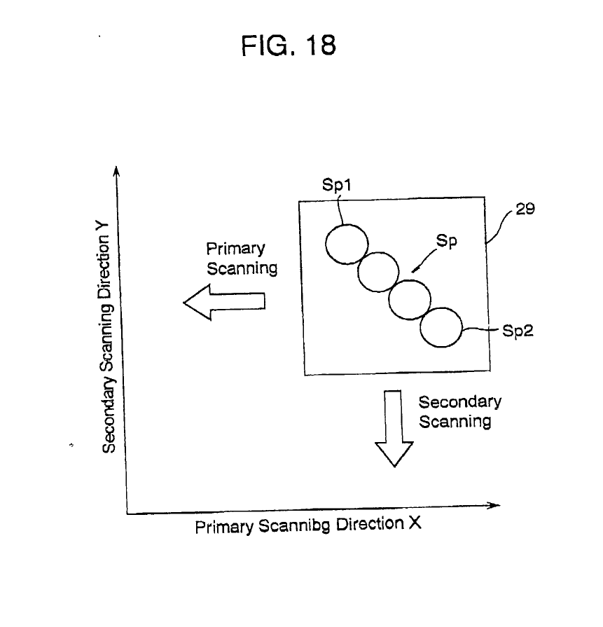

As shown in detail in FIG. 17, the stationary scanning head 29 projects the laser beams Lb so as to form a plurality of laser spots Sp arranged in a straight row on the back of the image transfer sheet 105. The straight row of laser spots Sp is inclined with respect to both primary and secondary scanning directions, namely both lengthwise and crosswise directions X and Y. As shown in more detail in FIG. 18, the straight row of laser spots Sp is desirably inclined so that the foremost laser spot Sp1 in the primary scanning direction X is positioned ahead of the foremost laser spot Sp2 in the secondary scanning direction Y as viewed in the primary scanning direction X. This arrangement of laser spots Sp causes gas produced locally at a scanned point to escape toward the lower reaches in the secondary scanning direction Y. This prevents the gas from staying between the toner layer 105c and the image receiving layer 87c in a scanned area, and hence maintains the tight adhesion between them, so as to eliminate an occurrence of image defects, resulting in a high quality of image.

Referring back to FIG. 3, the host computer 63 sends scanning data including data of an image such as pictures, letters, patterns, etc. and data of movement of the scanning stage 27 to the controller 59. The controller 59 controls the stationary scanning head 29 and the scanning stage 27 on the basis of the scanning data so as to scan the given area of the image transfer sheet 105 with the laser spots Sp, thereby forming a toner image of the given pattern. In the case of forming a color image, the scanning data comprise data of black, red, green and blue images.

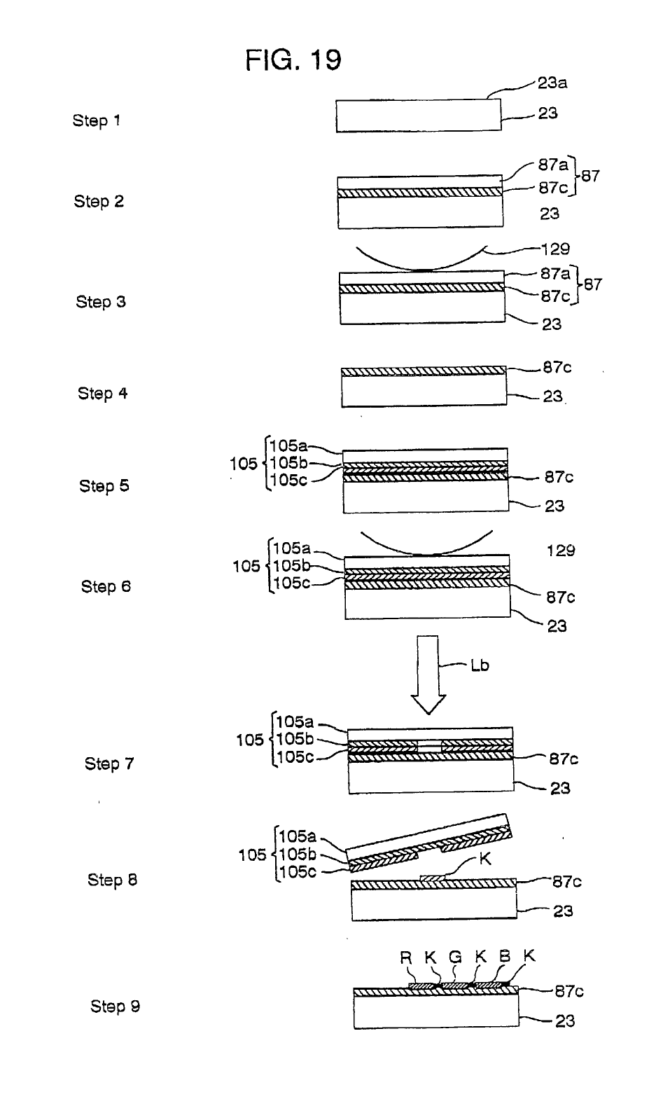

FIG. 19 conceptually illustrates an image recording process used to form a color filter with a black matrix on the non-flexible sheet member 23. After carrying a non-flexible sheet member 23 to the scanning station 40 from the feed device 33 by the carrying mechanism 49 and fixedly positioning it in the recess 71 of the scanning stage 27 (step 1), an image receiving sheet 87 is moved over the scanning station 40 and laid on the non-flexible sheet member 23 in the recess 71 of the scanning stage 27 and is subsequently pressed down by the pressure roller 129 so as thereby to be brought into adhesion with the non-flexible sheet member 23 (step 2). If desired, the image receiving sheet 87 is heated and pressed against the non-flexible sheet member 23 by a heat roller so as to be brought into tight adhesion with the non-flexible sheet member 23 (step 3). Subsequently, the image receiving sheet 87, specifically the support sheet 87a of the image receiving sheet 87 is peeled from the non-flexible sheet member 23 so as thereby to transfer the image receiving sheet 87 to the non-flexible sheet member 23 (step 4). The support 87a of the image receiving sheet 87 is moved out of the laser shading frame 41 through the egress/ingress aperture 41a and through away into the waste box 37. A black image transfer sheet 105 that has a black toner layer 105c is moved over the scanning station 40 and laid on the non-flexible sheet member 23 in the recess 71 of the scanning stage 27 and is subsequently pressed down by the pressure roller 129 so as thereby to be brought into adhesion with the non-flexible sheet member 23 (step 5). The black image transfer sheet 105 is subsequently heated and pressed against the non-flexible sheet member 23 by a heat roller like the image receiving sheet 87 (step 6).

Thereafter, the controller 59 controls the scanning mechanism 39 to scan the black image transfer sheet 105 on the basis of scanning data for a pattern of a black matrix with the laser spots Sp (step 7). Specifically, the controller 39 controls the scanning mechanism 39 so as to move the scanning stage 27 relative to the stationary scanning head 29 in synchronism with causing the stationary scanning head 29 to selectively project one or more laser spots Sp on the back of the image transfer sheet 105 on the basis of the scanning data.

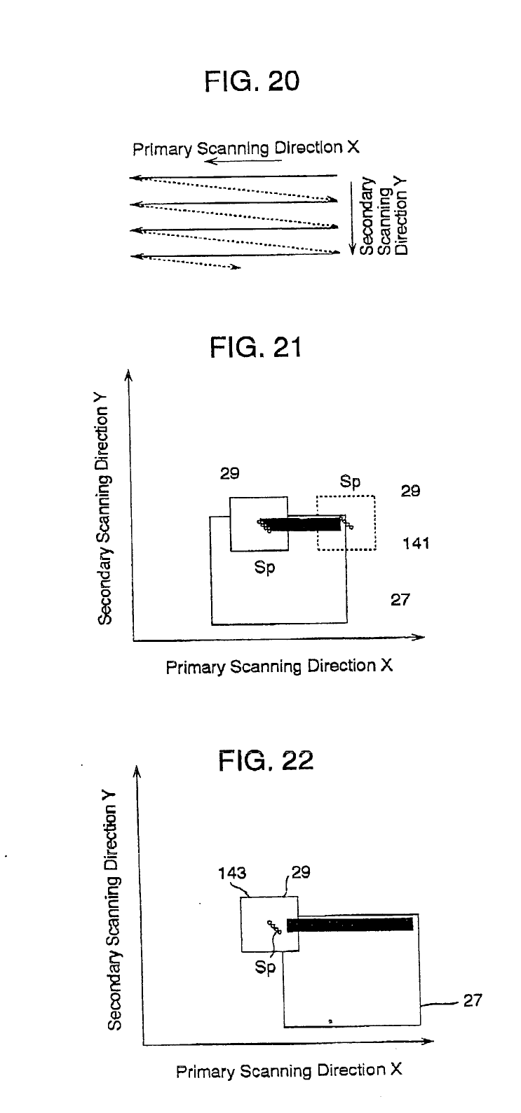

In this instance, as schematically shown in FIG. 20, the controller 59 performs the scanning of the image transfer sheet 105 by linear movement of the stationary scanning head 29 projecting the laser spots Sp relative to the scanning stage 27 from one end to another end of the image transfer sheet 105 in the primary scanning direction X and reverse movement of the stationary scanning head 29 projecting no laser spots Sp relative to the scanning stage 27 from the other end to the one end of the image transfer sheet 105 in the primary scanning direction X simultaneously with movement of the stationary scanning head 29 projecting no laser spots relative to the scanning stage 27 in the secondary scanning direction Y. The image transfer sheet 105 is entirely scanned by repeating the one-way liner scanning.

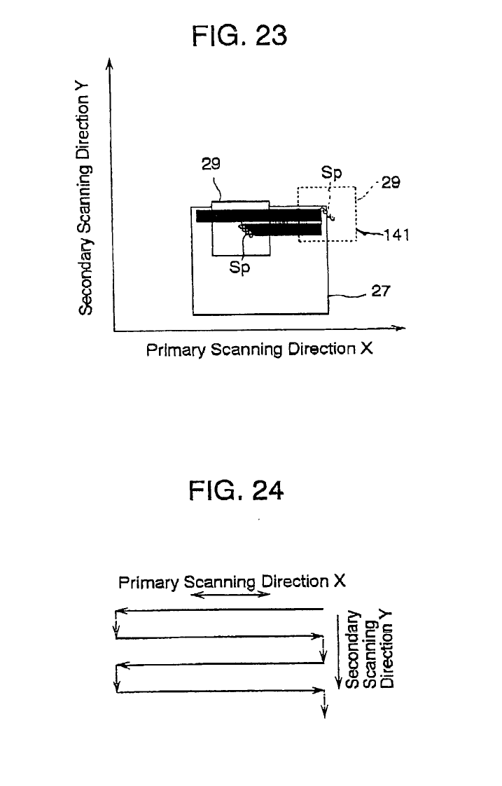

As shown in more detail in FIGS. 21 to 23, the stationary scanning head 29 starts projection of the laser spots Sp onto the image transfer sheet 105 at a given timing simultaneously with movement of the scanning stage 27 relative to the stationary scanning head 29 in a starting position 141 and continues selective projection of the laser spots Sp onto the image transfer sheet 105 on the basis of the scanning data for linear scanning in synchronism with the relative movement of the scanning stage 27 in the primary scanning direction X until the stationary scanning head 29 reaches an end position 143. When the relative movement of the scanning stage 27 brings the stationary scanning head 29 into the end position 143, the stationary scanning head 29 interrupts projection of the laser spots Sp. Subsequently, while the stationary scanning head 29 continuously interrupts projection of the laser spots Sp, reverse relative movement of the scanning stage 27 in the primary scanning direction X is made until the stationary scanning head 29 returns to the starting position 141 simultaneously with movement of the scanning stage 29 relative to the scanning stage 27 in the secondary direction Y by a distance equal to a length of the straight row of the laser spots Sp in the secondary scanning direction Y. The reciprocating movement of the stationary scanning head 29 relative to the scanning stage 27 between the starting and end positions 141 and 143 is repeated necessary times to scan the entire area of the image transfer sheet 105.

As a result of this scanning of the image transfer sheet 105, only areas of said photo-thermal conversion layer 105b generate heat in a pattern corresponding to areas of the image transfer sheet 105 exposed to the laser spots Sp and then, only areas of the image forming layer 105c of the image transfer sheet 105 affected by the heat are fused to the image recording surface of the non-flexible sheet member as a black toner image of the black matrix.

Since the serial scanning is accomplished by repeating one-way linear scanning in the primary scanning direction X always starting from the same point, it is easy to control the relative movement between the stationary scanning head 29 and the scanning stage 27 which leads to high image quality. The one-way scanning makes it hard to cause difference in image recording characteristics due to arrangement of a row of laser spots.

The serial scanning may be accomplished by repeating bi-directional linear scanning in the primary scanning direction X as shown in FIG. 24. In the bi-directional linear scanning, the stationary scanning head 29 is moved relative to the scanning stage 27 in the secondary scanning direction Y following linear scanning in the primary scanning direction X and then moved relative to the scanning stage 27 in the primary direction X for another linear scanning until the stationary scanning head 29 returns to the starting position. This bi-directional linear scanning can save scanning time as compared with the one-way linear scanning.

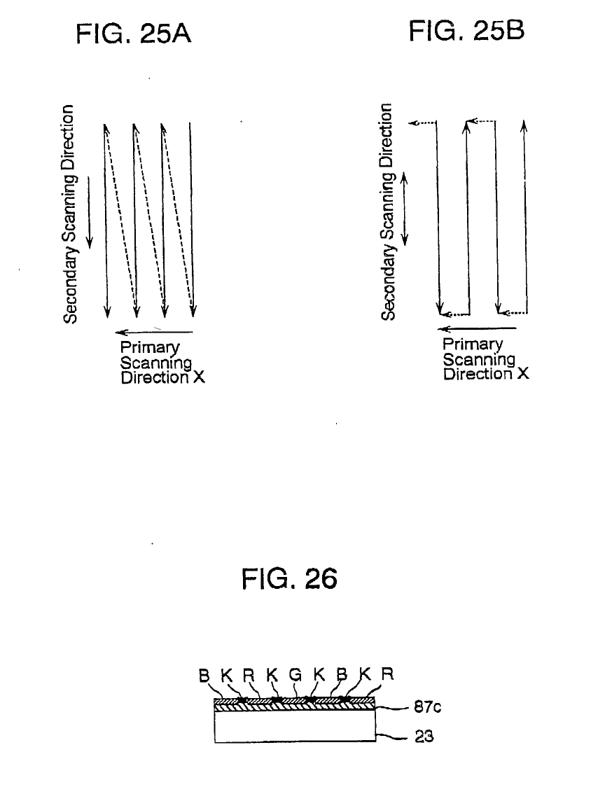

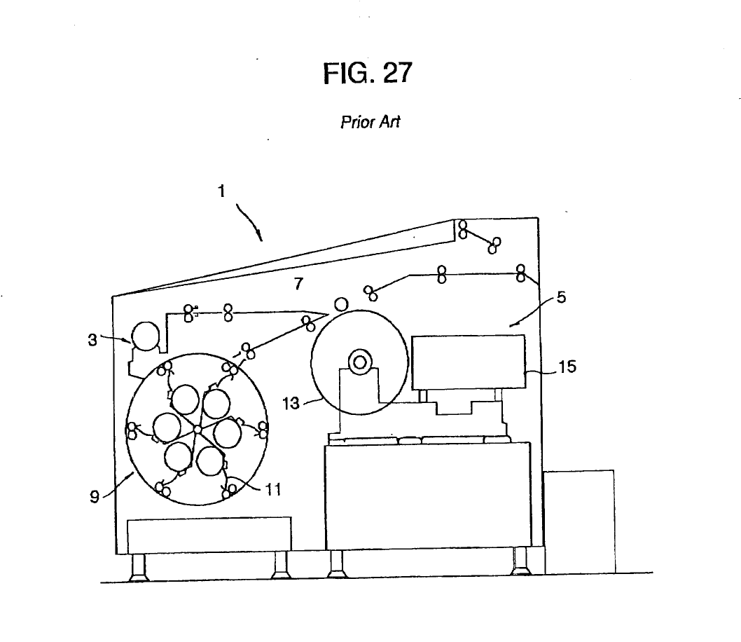

Further, as shown in FIGS. 25A and 25B, the primary scanning and the secondary scanning may be made in the lengthwise direction X and the crosswise direction Y, respectively. In this instance, the straight row of laser spots Sp is inclined with respect to both primary and secondary scanning directions.

Finally, when peeling the image transfer sheet 105 from the non-flexible sheet member 23, a positive toner pattern of the black matrix is left on the non-flexible sheet member (step 8).

A positive toner pattern of each of red (R), green (G) and blue (B) stripe patterns can be formed on the same non-flexible sheet member 23 in addition to the black toner matrix by repeating steps 5 through 8 of the process for the image transfer sheet 105 having a corresponding color, namely red (R), green (G) or blue (B), of image forming layer or toner layer 105c. As a result, the non-flexible sheet member 23 is formed a color filter comprising red (R), green (G), blue (B) and black (K) stripes arranged alternately in this order on the 87c on the image receiving layer 87c. (step 9).

The non-flexible sheet member 23 with a color filter formed thereon is removed from the scanning stage 27, carried out of the recording apparatus 21 and stacked up on the collection device 35 by the removal carrier mechanism 51. Specifically, after opening opens the air duct to the atmosphere so as to release the non-flexible sheet member 23 from the suction, the lift pins 73 are protruded to lift up the non-flexible sheet member 23 above the scanning stage 27. Subsequently the removal carrier mechanism 51 brings the carrier table 57 below the non-flexible sheet member 23 and then lifts it up until the suction pads 53 come into contact with the non-flexible sheet member 23. At this time, while the removal carrier mechanism 51 keeps the carrier table 57 in the lifted position, the air duct is closed to suck air between the suction pads 53 and the non-flexible sheet member 23 so that the suction pads 53 firmly hold the non-flexible sheet member 23. The removal carrier mechanism 51 resumes lifting up the carrier table 53 until the non-flexible sheet member 23 comes off the lift pins 73. Since the suction pads 53 hold the non-flexible sheet member 23 at the back opposite to the image forming surface 23a, the image formed on the non-flexible sheet member 23 is prevented from scratches.

Thereafter, the removal carrier mechanism 51 carries the carrier table 57 in a horizontal direction toward the collection device 35 out of the recording apparatus 21 from the scanning station 40 passing through the egress aperture 41b of the laser shading frame 41 and turns over the carrier table 57 during carrying it toward the collection device 35.

As shown in FIG. 3, the collection device 35 comprises a rack 47 on which a plurality of non-flexible sheet members 23 formed with an image are stacked up at regular separations like the feed device 33. The non-flexible sheet member 23 is placed with the image recording surface 23a down in the collection device 35. It is preferred to support the recording surface of the non-flexible sheet member 23 in point-contact so as to prevent alien substances from sticking to the recording surface 23a. For example, the point-contact support can be realized by the use of conical support pins 47b such as shown in FIG. 3.

Specifically, the rack 47 has a plurality of shelves 47a fixedly attached thereto at regular vertical separations. Four support pins 47b are arranged on each of the shelves 47a. The rack 47 is lifted up and down by a lift mechanism (not shown) so as to adjust a lowermost empty shelf 47a to a vertical position of the path of the carrier table 57. This lift mechanism may, for example, control a vertical position of the lowermost empty shelf 47a by detecting a weight or a thickness of one non-flexible sheet member 23 and lifting up the rack 47 by a specified vertical distance every time one non-flexible sheet member 23 is collected or by detecting a vertical position of the lowermost empty shelf 47a and lifting up or down the rack 47 so as to adjust the lowermost empty shelf 47a to the vertical position of the path of the carrier table 57.

When the carrier table 57 is placed above the lowermost empty shelf 47a of the rack 47, the removal carrier mechanism 51 lowers the carrier table 57 until the non-flexible sheet member is brought into contact with the support pins 47b and then stops it. After keeping the carrier table 57 stopped until the degree of vacuum in the inside of each suction pad 53 reaches a specified degree or the atmospheric pressure, the removal carrier mechanism 51 moves up the carrier table 57 so as to put the non-flexible sheet member 23 on the support pins 47b of the shelf 47 and subsequently to a ready position in close proximity to the egress aperture 41a of the laser shading frame 41 for access to another non-flexible sheet member 23 in the recording apparatus 21.

In the way described above, continuous production of a number of non-flexible sheet members 23 formed with desired images such as black matrix and a color filter is realized.

Although the above description has been directed to forming a color filter by transferring a black matrix (K) first and subsequently red (R), green (G) and blue (B) stripes onto the non-flexible sheet member 23, the black matrix (K) may be transferred onto the non-flexible sheet member 23 after the red (R), green (G) and blue (B) stripes as shown in FIG. 26. In this case, it is quite easy to form the black matrix (K) so as to overlap the red (R), green (G) and blue (B) stripes with the intention of reliably preventing the color filter from an escape of light at borders of the color stripes.

Although the above description has been directed to the image recording apparatus 21 in which the scanning stage 27 is moved relatively to the stationary scanning head 29 in the primary and secondary scanning directions X and Y, the scanning head 29 may be moved relatively to the stationary scanning stage 27 in the primary and secondary scanning directions X and Y with the same effect. Further, the arrangement of laser spots Sp is not always necessary to be arranged in a straight line.

It is to be understood that although the present invention has been fully described by way of the preferred embodiments thereof with reference to the accompanying drawings, various variant and other embodiments may occur to those skilled in the art. Unless these variants and embodiment depart from the scope of the present invention, they are intended to be covered by the following claims.

What is claimed is:

1. An image forming method of forming an image on a non-flexible sheet member having an image forming surface that is positioned in a scanning station by transferring an image formed in an image transfer sheet having a photo-thermal conversion layer and an image forming layer to the non-flexible sheet member, said image forming method comprising the steps of:
laying said image transfer sheet on said non-flexible sheet member with said image forming layer in tight adhesion to said image recording surface of said non-flexible sheet member;
scanning said image transfer sheet from the back with a plurality of laser spots so that only areas of said image forming layer affected by heat developed in said photo-thermal conversion layer correspondingly to a pattern of exposure to said laser spots are fused to said image recording surface of said non-flexible sheet member; and
peeling said image transfer sheet from said non-flexible sheet member so as thereby to form a positive reproduction of said image on said non-flexible sheet member.

2. An image forming method as defined in claim 1, wherein said steps are repeated for a plurality of said image transfer sheets having image forming layers different in color from one another.

3. An image forming method as defined in claim 2, and further comprising the steps of laying an image receiving sheet having an image receiving layer on said non-flexible sheet member, tightly adhering said image receiving layer to said image forming surface of said non-flexible sheet member and peeling said image receiving sheet from said non-flexible sheet member so as thereby to transfer said image receiving layer to said non-flexible sheet member as said image forming surface.

4. An image forming method as defined in claim 3, and further comprising the step of heating and pressing said image receiving sheet against said non-flexible sheet member so as thereby to bring said image receiving layer into tight adhesion to said image forming surface of said non-flexible sheet member

5. An image forming method as defined in claim 1, wherein said steps are repeated for said image transfer sheets having black, red, green and blue image forming layers, respectively.

6. An image forming method as defined in claim 5, wherein said steps are finally repeated for said image transfer sheets having said black image forming layer.

7. An image forming method as defined in claim 6, and further comprising the steps of laying an image receiving sheet having an image receiving layer on said non-flexible sheet member with said image receiving layer in tight adhesion to said image forming surface and peeling said image receiving sheet from said non-flexible sheet member so as to transfer said image receiving layer to said non-flexible sheet member as said image forming surface.

8. An image forming method as defined in claim 7, and further comprising the step of heating and pressing said image receiving sheet against said non-flexible sheet member so as thereby to bring said image receiving layer into tight adhesion to said image forming surface of said non-flexible sheet member

9. An image forming method as defined in claim 1, wherein said non-flexible sheet member has a flexibility defined by a longitudinal modulus greater than a specified value and the product of said longitudinal modulus and a geometrical moment of inertia greater than a specified value.

10. An image forming method as defined in claim 1, wherein said scanning of said image transfer sheet is performed by repeating liner movement of said laser spot relative to said non-flexible sheet member between opposite ends of said non-flexible sheet member in a primary scanning direction and reverse liner movement of said laser spot relative to said non-flexible sheet member between said opposite ends of non-flexible sheet member in said primary scanning direction simultaneously with movement of said laser spot relative to said non-flexible sheet member in a secondary scanning direction perpendicular to said primary direction.

11. An image forming method as defined in claim 1, wherein said scanning said image transfer sheet is performed by repeating liner movement of said laser spot relative to said non-flexible sheet member between opposite ends of said non-flexible sheet member in a primary scanning direction, movement of said laser spot relative to said non-flexible sheet member in a secondary scanning direction perpendicular to said primary scanning direction, and reverse liner movement of said laser spot relative to said non-flexible sheet member between said opposite ends of non-flexible sheet member in said primary scanning direction.

12. An image forming apparatus for forming an image on a non-flexible sheet member having an image forming surface that is fixedly placed in a recording position by the use of an image transfer sheet having a photo-thermal conversion layer and an image forming layer, said image forming apparatus comprises:
a scanning stage for supporting said non-flexible sheet member thereon;
image transfer sheet feed means for feeding and laying said image transfer sheet on non-flexible sheet member;
a pressure roller operative to press said image transfer sheet so as to being said image forming layer into tight adhesion to said image recording surface of said non-flexible sheet member;
scanning means for scanning said image transfer sheet from the back with a plurality of laser spots so that only areas of said image forming layer affected by heat developed in said photo-thermal conversion layer correspondingly to a pattern of exposure to said laser spots are fused to said image recording surface of said non-flexible sheet member; and
peeling means for peeling said image transfer sheet from said non-flexible sheet member so as thereby to form a positive reproduction of said image on said non-flexible sheet member.

13. An image forming apparatus as defined in claim 12, wherein said scanning means comprises a scanning head selectively projecting said laser spots and table drive means for causing relative movement between said scanning head and said scanning stage.

14. An image forming apparatus as defined in claim 12, and further comprising non-flexible sheet member feed means for picking an uppermost non-flexible sheet member from a stack of a plurality of said non-flexible sheet members and carrying and laying said uppermost non-flexible sheet member on said scanning stage and removing means for removing said non-flexible sheet member formed with said image from said scanning stage.

15. An image forming apparatus as defined in claim 14, wherein said non-flexible sheet member feed means picks up said uppermost non-flexible sheet member with said image forming surface faced down by attracting the back of said non-flexible sheet member opposite to said image forming surface by suction and turns over said uppermost non-flexible sheet member during carrying said uppermost non-flexible sheet member to said scanning stage.

16. An image forming apparatus as defined in claim 14, wherein said removing means lifts up said non-flexible sheet member formed with said image from said scanning stage, attracts the back of said non-flexible sheet member by suction and removing said non-flexible sheet member formed with said image from said scanning stage.

17. An image forming apparatus as defined in claim 12, and further comprising image receiving sheet feed means for feeding and laying an image receiving sheet having an image receiving layer on said non-flexible sheet member with said image receiving layer in tight adhesion to said image forming surface, wherein said image receiving sheet is peeled from said non-flexible sheet member by said peeling means so as to transfer said image receiving layer to said non-flexible sheet member as said image forming surface before said image transfer sheet is laid on said non-flexible sheet member.

18. An image forming apparatus as defined in claim 12, wherein said laser spots are arranged in a straight row inclined with respect to primary and secondary scanning directions perpendicular to each other so that so that a foremost laser spot in a primary scanning direction is positioned ahead of a foremost laser spot in a secondary scanning direction as viewed in said primary scanning direction.

19. An image forming apparatus as defined in claim 12, wherein said scanning stage is formed with a recess defined by side walls, said recess having a depth substantially equal to a thickness of said non-flexible sheet member and an area greater than an area of said non-flexible sheet member so as to receive said non-flexible sheet member with an allowance left between said non-flexible sheet member and said wall in each of crosswise and lengthwise directions.

20. An image forming apparatus as defined in claim 12, and further comprising offset means installed in each of said side walls adjacent to each other for urging and offsetting said non-flexible sheet member against said side wall opposite to said each said side wall.

21. An image forming apparatus as defined in claim 12, and further comprising lift means for supporting and lifting up said non-flexible sheet member, said lift means comprising a plurality of pins installed to a bottom of said recess of said scanning stage so as to protrude from and retract on said bottom of said recess.

22. An image forming apparatus as defined in claim 21, wherein said peeling means comprises a plurality of peeling claws and socket grooves formed in said wall of said recess of said scanning stage, said peeling claw being moved into said socket groove and then upward so as to lift up and peel said image transfer sheet from said non-flexible sheet member.

23. An image forming apparatus as defined in claim 21, and further comprising suction means for fixedly attract said non-flexible sheet member to a bottom of said recess of said scanning stage.

24. An image forming apparatus as defined in claim 21, wherein said suction means comprises a plurality of suction nozzles formed in said bottom of said recess of said scanning stage and a source of suction connected to said suction nozzles.

25. An image forming apparatus as defined in claim 21, wherein said suction means further comprises a plurality of suction nozzles formed in said walls of said recess of said scanning stage and connected to said source of suction.
